(19) United States
(12) Patent Application Publication
(10) Pub. No.: US 2011/0225779 A1
(43) Pub. Date: Sep. 22, 2011

(54) Bungee cord assembly

(76) Inventor: Mack E. Jones, Palm Springs, CA (US)

(21) Appl. No.: 12/931,912

(22) Filed: Feb. 14, 2011

Related U.S. Application Data
(60) Provisional application No. 61/340,723, filed on Mar. 22, 2010.

(51) Int. Cl. B60P 7/00

(52) U.S. Cl. 24/301

(57) ABSTRACT

A bungee cord assembly and related methodology is provided for securing an object (e.g., a truck-bed-covering tarp) to a vehicle by threading a bungee cord portion of the assembly through an opening in the object (e.g., an eyelet) and then adjusting bungee-cord operative length for a desired tension. A hook member on a first end portion of the bungee cord enables a user to secure the first end portion to the vehicle. A second-end-portion-engaging keeper member is included that enables the user to secure a second end portion of the bungee cord to the rest of the bungee cord after threading the second end portion through the opening in the object in order to secure the object with user-adjustable bungee-cord tension. The keeper member is hookless to avoid hook-related damage by the adjustable keeper member to the vehicle.

### CROSS REFERENCE TO RELATED APPLICATION

This application claims the benefit of U.S. Provisional Patent Application Ser. No. 61/340,723 filed Mar. 22, 2010.

### BACKGROUND OF THE INVENTION

1. Technical Field

This invention relates generally to the fields of fastening devices and automotive accessories, and more particularly to a bungee cord assembly and related methodology for securing a fitted pickup-truck-bed-covering tarp, or other object, to a vehicle.

2. Description of Related Art

U.S. Pat. No. D584,677(S) issued Jan. 13, 2009 to Mack E. Jones describes a fitted pickup-truck-bed-covering tarp that helps one visualize problems associated with the prior art. A user places the tarp over the pickup bed and then secures the tarp in place with rope, cord, ties, or other fastening means. Sometimes, the user will use a long cord or rope, tie it to an eyelet on the tarp, and then string it alternately through structure on the truck and other eyelets on the tarp while drawing it taut enough to secure the tarp as desired. Doing so can be somewhat inconvenient and time consuming, and so the user often selects bungee cords instead. The user places a first hook provided on a first end of a bungee cord through an eyelet on the tarp, and then he secures a second hook provided on a second end of the bungee cord to a rocker panel, fender, bumper, or other truck structure. That procedure is repeated using other bungee cords, other eyelets, and other truck structure in way that tightly secures the tarp in place over the bed of the pickup truck.

A typical bungee cord (sometimes called a “bungee”) includes one or more elastic strands that form a core. The core is covered with a woven nylon or cotton sheath, although some specialized bungee cord may be made entirely of elastic strands. It is a well-known and commonly used item. One problem that can arise with using bungee cords, however, is that the length may not be quite right for the particular use. A bungee cord may be too long for some tie-down applications and too short for others. To compensate, the user sometimes loops a bungee cord over additional truck structure to use up the extra length. He may even tie a knot in the bungee cord.

Another problem concerns damage to the truck finish. The bungee cord hook often contacts and scratches the truck finish. The hook may continually rub against the finish in transit and thereby damage it. This is particularly true of a hook extending through an eyelet on a tarp because the eyelet is usually located directly over a finished portion of the truck body. For these and other reasons, users need a better way to secure a tarp with bungee cords.

### SUMMARY OF THE INVENTION

In view of the foregoing, it is an object of the present invention to provide a bungee cord assembly and related methodology that alleviate the foregoing concerns. The present invention achieves this objective by providing a bungee cord assembly having a hookless bungee cord keeper member that enables a user to secure a second end portion of a bungee cord to a tarp by passing the second end portion through an eyelet on the tarp. The keeper member is a cord-gripping device (i.e., a cord-locking device) that does not include a hook. The user passes the second end portion of the bungee cord through a first passageway in the keeper, then through the eyelet on a tarp, and then back through a second passageway in the keeper, with the keeper gripping the second end portion within the second passageway for a user-desired operative bungee-cord length and associated bungee-cord tension. This occurs while avoiding hook-related damage to the truck finish. There is no hook on the tarp end of the bungee cord and no knot is needed in the bungee cord to secure it to the eyelet.

To paraphrase some of the more precise language appearing in the claims and further introduce the nomenclature used, the invention provides a bungee cord assembly for enabling a user to secure a truck-bed-covering tarp or other object to a vehicle by passing a portion of the bungee cord assembly through an eyelet in the tarp then adjusting bungee-cord operative length for a desired bungee-cord tension. The assembly includes a bungee cord having a first end portion, a second end portion, and a mid portion extending between the first and second end portions. A hook member on the first end portion serves as first means for enabling a user to secure the first end portion of the bungee cord to the vehicle. A cord-gripping keeper member serves as second means for enabling the user to secure the second end portion of the bungee cord to the mid portion of the bungee cord after the user passes the second end portion of the bungee cord through the eyelet on the tarp in order to achieve a user-desired operative bungee-cord length. The cord-gripping keeper member enables the user to adjust the operative length of the bungee cord for a desired bungee-cord tension, and it is hookless to avoid hook-related damage to the vehicle.

In one preferred embodiment of the cord-gripping keeper member, the cord-gripping keeper member defines a first passageway having a size and shape such as to enable the user to pass the second end portion of the bungee cord through the first passageway before passing the second end portion through the eyelet. In addition, the cord-gripping keeper member defines a second passageway having a size and shape such as to enable the user to pass the second end portion of the bungee cord through the second passageway after passing the second end portion through the eyelet. Gripping means are provided as a part of the cord-gripping keeper member for gripping the second end portion of the bungee cord within the second passageway to achieve the user-desired operative bungee-cord length.

In line with the foregoing, a method for enabling a user to secure a tarp or other object to a vehicle using a tie-down eyelet on the tarp includes the steps of (a) providing a bungee cord having a first end portion, a second end portion, and a mid portion extending between the first and second end portions, and (b) providing a cord-gripping keeper member that defines first and second passageways and includes gripping means for gripping the bungee cord within the second passageway. The method proceeds by (c) passing the second end portion of the bungee cord through the first passageway in a first direction, (d) passing the second end portion of the bungee cord through the tie-down eyelet on the tarp (e) passing the second end portion of the bungee cord through the second passageway in a second direction opposite to the first direction, and (f) using the gripping means of the cord-gripping keeper member to secure the second end portion of the bungee cord within the second passageway to achieve a user-desired operative length of the bungee cord.

Thus, the invention enables a user to tie-down a tarp tie-down by passing bungee cords through eyelets on the tarp using cord-gripping keeper members that avoid hook-related damage to the vehicle finish by having no hooks. The following illustrative drawings and detailed description make the foregoing and other objects, features, and advantages of the invention more apparent.

### BRIEF DESCRIPTION OF THE DRAWINGS

FIG. 1 of the drawings is a perspective view of a portion of the forward corner of a fitted pickup-truck-bed-covering tarp that is shown secured on a pickup truck with four bungee cord assemblies constructed according to the invention;

FIG. 2 of the drawings is an enlarged view of one of the bungee cord assemblies in FIG. 1 that is shown prior to the cord being secured with the bungee cord keeper;

FIG. 3 is a further enlarged view of the bungee cord keeper of FIG. 2 that is shown prior to the cord being secured with the bungee cord keeper;

FIG. 4 is an enlarged view of the bungee cord keeper similar to FIG. 3 that shown with the cord secured with the bungee cord keeper;

FIG. 5 is a cross sectional view of the bungee cord keeper as viewed in a bisecting plane through the bungee cord keeper that contains a line 5-5 in FIG. 4;

FIG. 6 is an enlarged cross sectional view of the bungee cord keeper similar to FIG. 5, but with the bungee cord omitted; and

FIG. 7 is an enlarged view of the bungee cord assembly of FIG. 2 that shows the bungee cord secured with the bungee cord keeper.

### DESCRIPTION OF THE PREFERRED EMBODIMENTS

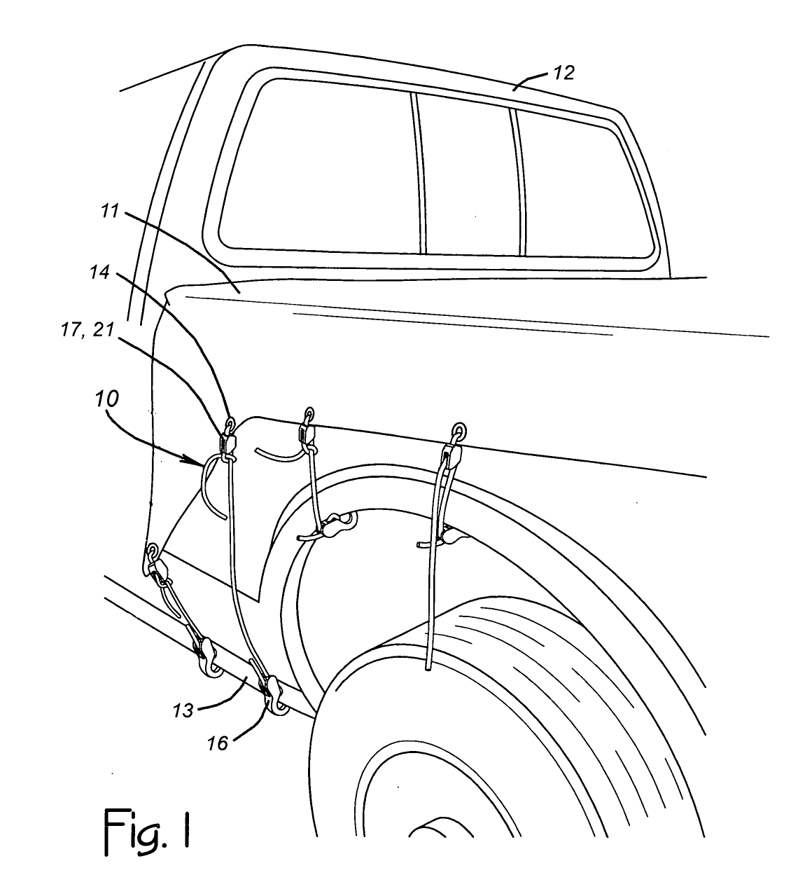

FIGS. 1-7 of the drawings show various aspects of a bungee cord assembly 10 constructed according to the invention. It is shown in use in FIG. 1, securing a fitted pickup-truck-bed-covering tarp 11 to a pickup truck 12. The truck 12 represents any of various known types of vehicles, while the tarp 11 represents any of various objects that a user may want to secure to the truck 12, including, for example, any of various bed-covering tarps that are commercially available from Qwik Tarp, Inc. of Palm Springs, Calif. The bungee cord assembly 10 secures the tarp 11 on the vehicle 12 by hooking onto a rocker panel 13 of the truck 12 and passing through an eyelet 14 on the tarp 11.

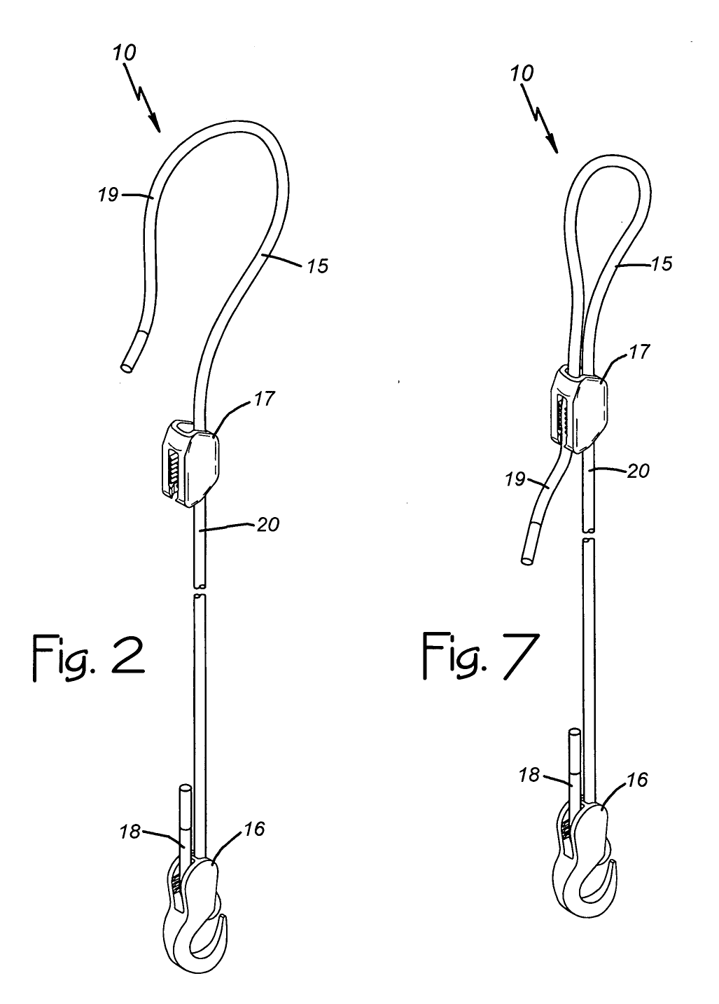

Generally, the assembly 10 includes a bungee cord 15 (FIGS. 2 and 7) along with a hook member (i.e., a hook 16) and a keeper member (i.e., a keeper 17). The bungee cord 15 is shown foreshortened in FIGS. 2 and 7 for illustrative purposes. It may take the form of a length of any of various known types of bungee cords (e.g., one having a 0.25-inch outside diameter). It has a first end portion 18, a second end portion 19, and a mid portion 20 extending between the first and second end portions 18 and 19 (FIGS. 2 and 7).

The hook 16 functions as first means for enabling a user (not shown) to secure the first end portion 18 of the bungee cord 15 to a vehicle (e.g., the vehicle 12 in FIG. 1). It may take the form of a commercially available molded plastic piece (e.g., 3-inch overall length) that the user secures removably to the first end portion 18 of the bungee cord 15.

The keeper 17 functions as second means for enabling the user to secure the second end portion 19 of the bungee cord 15 to the mid portion 20 of the bungee cord 15 after the user passes the second end portion 19 of the bungee cord 15 through an eyelet on a tarp (e.g., the eyelet 14 on the tarp 11 in FIG. 1) in order to secure the tarp in place. The keeper 17 includes a block of material (e.g., a molded plastic block) with the features described later is this specification. The keeper 17 enables the user to use the eyelet 14 for tarp-securing purposes without using a hook to engage the eyelet 14. The user threads the second end portion 19 through the eyelet 14 (i.e., strings or passes it through) and, instead of tying a knot in the bungee cord 15, the user secures the second end portion 19 to the mid portion 20 using the keeper 17. The keeper 17 enables the user to do so while achieving a user-desired operative bungee-cord length and associated bungee-cord tension.

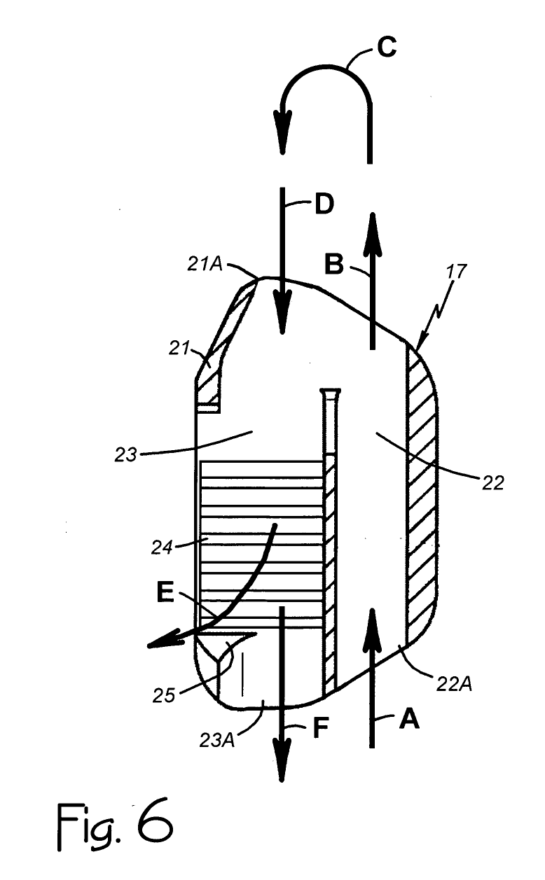

Further details of the keeper 17 and its use are shown in FIGS. 3-7. It may take the form of a molded plastic block that is designated as a block 21 in FIG. 6. As an idea of size, the illustrated block 21 is about 2.0 inches in overall length measured at its longest portion parallel to the left and right margins of the drawing sheet on which FIG. 6, about 1.1 inches in overall width measured at its widest portion perpendicular to said left and right margins, and about 0.63 inches in overall thickness measured at its thickest portion perpendicular to said drawing sheet. Of course, those dimensions may vary without departing from the inventive aspects disclosed.

The keeper 17 defines a first passageway 22 (FIG. 6) through which the first end portion 19 of the bungee cord 15 fits (i.e., the user can readily pass the first end portion 19 through the first passageway 22). The keeper 17 also defines a second passageway 23 (FIG. 6) through which the first end portion 19 of the bungee cord 15 fits (i.e., the user can readily pass the first end portion 19 through the second passageway 23. The block 21 includes a plurality of inwardly extending protrusions 24 (FIG. 6) that help grip the first end portion 19 of the bungee cord 15, while a locking protrusion 25 provides added gripping in order to lock the first end portion 19 at a user-desired position resulting in a user-desired operative length of the to bungee cord 15 and an associated bungee-cord tension.

To use the keeper 17, the user passes the second end portion 19 of the bungee cord 15 into an entrance 22A portion of the first passageway 22, as depicted by an arrow A in FIG. 6. The user then continues threading the first end portion 19 through the first passageway 22, as depicted by an arrow B in FIG. 6, to result in the configuration shown in FIG. 3. Then, the user loops the first end portion 19 through an eyelet on the tarp (e.g., the eyelet 14 in FIG. 1), as depicted by an arrow C in FIG. 6, to result in the bungee cord assembly 10 being in the configuration shown in FIG. 2. The tarp 11 and the eyelet 14 are not shown in FIG. 2, for illustrative purposes.

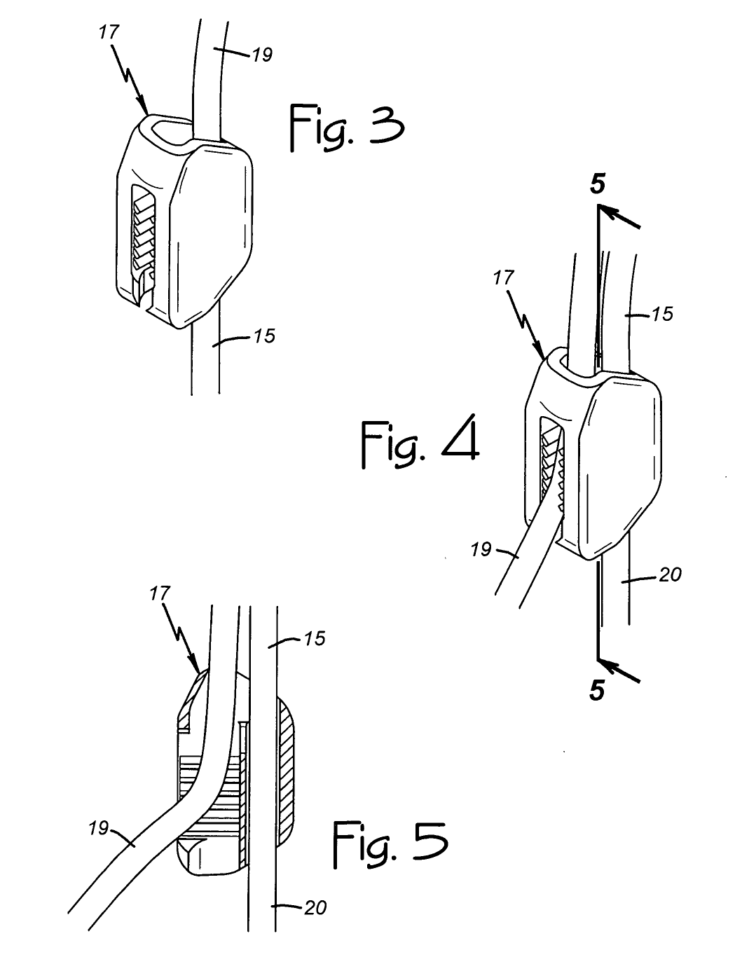

Next, the user passes the first end portion 19 through the second passageway 23 in the block 21, as depicted by arrows D and E in FIG. 6, with the protrusions 24 providing some gripping of the first end portion 19. Doing so results in the configuration shown in FIGS. 4 and 5. The user continues drawing the first end portion through the block 21, until an upper end portion 21A of the block 21 is disposed against the eyelet 14 and until the user achieves the desired operative length of the bungee cord 15 with its associated bungee-cord tension. The upper end portion 21A of the block 21 is identified in FIG. 6 and the position of the block 21 against the eyelet 14 is shown in FIG. 1.

The “operative length” of the bungee cord 15 is that portion of the bungee cord 15 extending between the hook 16, through the keeper 17, to the eyelet 14 (or other opening through which the first end portion 19 passes in a loop). After user draws the first end portion 19 of the bungee cord 15 through the keeper 17 sufficiently to achieve the user-desired operative length (with its associated bungee-cord tension), the user locks the first end portion 19 of the bungee cord 15 in place in the keeper 17 by moving it to the position indicated by an arrow F in FIG. 6. In that position, the first end portion 19 extends out of an exit 23A of the second passageway that is identified in FIG. 6, with the locking protrusion 25 firmly gripping the first end portion 19 and holding it in place relative to the keeper 17. That all results in the bungee cord assembly 10 being in the configuration shown in FIG. 7. The tarp 11 and the eyelet 14 are not shown in FIG. 7, for illustrative purposes.

Recapitulating the methodology of the present invention, a method is provided for enabling a user to secure a tarp having a tie-down eyelet on the tarp (e.g., a truck-bed-covering tarp or other object) to a vehicle while avoiding hook-related damage. The method includes the steps of (a) providing a bungee cord having a first end portion, a second end portion, and a mid portion extending between the first and second end portions and (b) providing a cord-gripping keeper member that defines first and second passageways and includes gripping means for gripping the bungee cord within the second passageway. The method proceeds by \textcircled{C}) passing the second end portion of the bungee cord through the first passageway in a first direction, (d) passing the second end portion of the bungee cord through the tie-down eyelet on the tarp, (e) passing the second end portion of the bungee cord through the second passageway in a second direction opposite to the first direction, and (f) using the gripping means of the cord-gripping keeper member to secure the second end portion of the bungee cord within the second passageway to achieve a user-desired operative length of the bungee cord.

Thus, the invention provides a bungee cord assembly and methodology that enables a user to secure a bungee cord to a tarp by passing a portion of the bungee cord through an eyelet on the tarp and using a cord-gripping keeper member to achieve a user-desired operative bungee-cord length and associated bungee-cord tension. This occurs while avoiding hook-related damage to the truck finish. Although exemplary embodiments have been shown and described, one of ordinary skill in the art may make many changes, modifications, and substitutions without necessarily departing from the spirit and scope of the invention. As for the specific terminology used to describe the exemplary embodiments, it is not intended to limit the invention; each specific term is intended to include all technical equivalents that operate in a similar manner to accomplish a similar purpose or function.

What is claimed is:

1. A bungee cord assembly for enabling a user to secure a tarp (e.g., a truck-bed-covering tarp or other object) to a vehicle by passing a portion of the bungee cord assembly through an eyelet on the tarp (or other hole in the tarp or other object), the bungee cord assembly comprising:
a bungee cord having a first end portion, a second end portion, and a mid portion extending between the first and second end portions;
first means for enabling a user to secure the first end portion of the bungee cord to the vehicle, said first means including a hook member on the first end portion of the bungee cord; and
second means for enabling the user to secure the second end portion of the bungee cord to the mid portion of the bungee cord after the user passes the second end portion of the bungee cord through the eyelet on the tarp in order to achieve a user-desired operative bungee-cord length, said second means including a cord-gripping keeper member on the bungee cord;
wherein the cord-gripping keeper member is hookless to avoid hook-related damage to the vehicle.

2. A bungee cord assembly as recited in claim 1, wherein:
the cord-gripping keeper member defines a first passageway having a size and shape such as to enable the user to pass the second end portion of the bungee cord through the first passageway before passing the second end portion through the eyelet;
the cord-gripping keeper member defines a second passageway having a size and shape such as to enable the user to pass the second end portion of the bungee cord through the second passageway after passing the second end portion through the eyelet; and
the cord-gripping keeper member includes gripping means for gripping the second end portion of the bungee cord within the second passageway to achieve the user-desired operative bungee-cord length.

3. A method for enabling a user to secure a tarp having a tie-down eyelet on the tarp (e.g., a truck-bed-covering tarp or other object) to a vehicle while avoiding hook-related damage, the method comprising:
providing a bungee cord having a first end portion, a second end portion, and a mid portion extending between the first and second end portions;
providing a cord-gripping keeper member that defines first and second passageways and includes gripping means for gripping the bungee cord within the second passageway;
passing the second end portion of the bungee cord through the first passageway in a first direction;
passing the second end portion of the bungee cord through the tie-down eyelet on the tarp;
passing the second end portion of the bungee cord through the second passageway in a second direction opposite to the first direction; and
using the gripping means of the cord-gripping keeper member to secure the second end portion of the bungee cord within the second passageway to achieve a user-desired operative length of the bungee cord.
